(19) United States
(12) Patent Application Publication
(10) Pub. No.: US 2015/0177542 A1
(43) Pub. Date: Jun. 25, 2015

(54) DISPLAY APPARATUS

(71) Applicant: KYOCERA Corporation, Kyoto-shi, Kyoto (JP)

(72) Inventor: Hiroaki Katou, Yasu-shi (JP)

(73) Assignee: KYOCERA Corporation, Kyoto-shi, Kyoto (JP)

(21) Appl. No.: 14/409,661

(22) PCT Filed: Nov. 12, 2013
(86) PCT No.: PCT/JP2013/080570

§ 371 Date: Dec. 19, 2014

(30) Foreign Application Priority Data
Nov. 29, 2012 (JP) 2012-260502

(51) Int. Cl. G02F 1/1345; G02F 1/1339; G02F 1/1333

(52) U.S. Cl. CPC G02F 1/1345; G02F 1/13338; G02F 1/1339

(57) ABSTRACT

A display apparatus is configured so that, between a first substrate and a second substrate, a first spacer member disposed along an edge of an outer main surface of the first substrate at one side of an outer region of a circuit board on an extension of a disposition direction of a plurality of electrode terminals and a second spacer member disposed along the edge of the outer main surface of the first substrate at the other side of the outer region are disposed.

### TECHNICAL FIELD

The present invention relates to a display apparatus for use in various applications such as a mobile phone, a digital camera, a handheld video game machine, and a portable information terminal apparatus.

### BACKGROUND ART

For example, among display apparatuses, a liquid crystal display apparatus includes a first substrate having a display region in an outer main surface thereof, a second substrate disposed relative to the first substrate so that an inner main surface of the second substrate and an inner main surface of the first substrate are opposite to each other, a liquid crystal layer disposed between the first substrate and the second substrate, and a sealing member disposed to surround the liquid crystal layer.

Further, among such liquid crystal display apparatuses, an input function-equipped liquid crystal display apparatus includes, in addition to the constituent elements described above, detection electrodes for detecting a change in capacitance between the outer main surface of the first substrate and input means such as a finger, a plurality of electrode terminals for external connection electrically connected to the detection electrodes, and a circuit board connected to the plurality of electrode terminals via a conductive bonding member (refer to, for example, JP 2008-134522 A).

In the input function-equipped display apparatus described above, when the electrode terminals for external connection are disposed in proximity to the sealing member, heat, pressing force, and the like applied when the plurality of electrode terminals are connected by thermocompression bonding to the circuit board via the conductive bonding member exert an influence on the display region, and consequently may cause degradation in display quality, such as display unevenness in some cases.

On the other hand, when the plurality of electrode terminals are disposed along one side of the outer main surface of the first substrate so as to be spaced apart from the sealing member, satisfactory pressing force cannot be applied upon connection of the electrode terminals to the circuit board in some cases.

On the other hand, by providing a spacer member between the first substrate and the second substrate and throughout one side of the first substrate where the plurality of electrode terminals are disposed, satisfactorily strong pressing force can be applied upon connection of the plurality of electrode terminals to the circuit board.

However, when the spacer member is disposed throughout one side of the first substrate, the spacer member overlays a connection region where the plurality of electrode terminals are connected to the circuit board, so that the connection state between the plurality of electrode terminals and the circuit board cannot be verified from the inner main surface of the first substrate in some cases.

The invention has been devised in view of the problem described above, and an object thereof is to provide a display apparatus that allows verification of a connection state between a plurality of electrode terminals and a circuit board while suppressing degradation in display quality, thereby ensuring connection reliability between the electrode terminals and the circuit board.

### SUMMARY OF INVENTION

According to the invention, a display apparatus includes: a first substrate having in an outer main surface thereof a display region and an input region which overlays the display region; a second substrate disposed relative to the first substrate so that an inner main surface of the second substrate and an inner main surface of the first substrate are opposite to each other; a sealing member disposed between the first substrate and the second substrate so as to surround a region which overlays the display region; display means for displaying image information on the display region, the display means being disposed between the first substrate and the second substrate in the region which overlays the display region; detection electrodes disposed on the outer main surface of the first substrate so as to overlay the input region; a plurality of electrode terminals for external connection disposed along an edge of the outer main surface of the first substrate in a region which overlays a region of the second substrate which region is located outside the input region, the electrode terminals being electrically connected to the detection electrodes; and a circuit board disposed to be opposite to the plurality of electrode terminals and connected to the electrode terminals via a conductive bonding member. In the display apparatus, a first spacer member disposed along the edge of the outer main surface of the first substrate at one side of an outer region of the circuit board on an extension of a disposition direction of the plurality of electrode terminals and a second spacer member disposed along the edge of the outer main surface of the first substrate at the other side of the outer region are disposed between the first substrate and the second substrate.

### BRIEF DESCRIPTION OF DRAWINGS

FIG. 1 is a plan view showing a display apparatus according to a first embodiment of the invention;

FIG. 2 is a sectional view taken along the line I-I in FIG. 1;

FIG. 3 is a plan view showing an electrode, lines, a thin-film transistor, and the like disposed on a second substrate of the display apparatus shown in FIG. 1;

FIG. 4 is a sectional view showing the display apparatus taken along the line II-II in FIG. 3;

FIG. 5 is a plan view showing a detection electrode, a detecting line, an electrode terminal, a first circuit board, and first to third spacer members in the display apparatus shown in FIG. 1;

FIG. 6 is a sectional view taken along the line in FIG. 1; and

FIG. 7 is a plan view showing a main part of a display apparatus according to a second embodiment of the invention.

### DESCRIPTION OF EMBODIMENTS

### First Embodiment

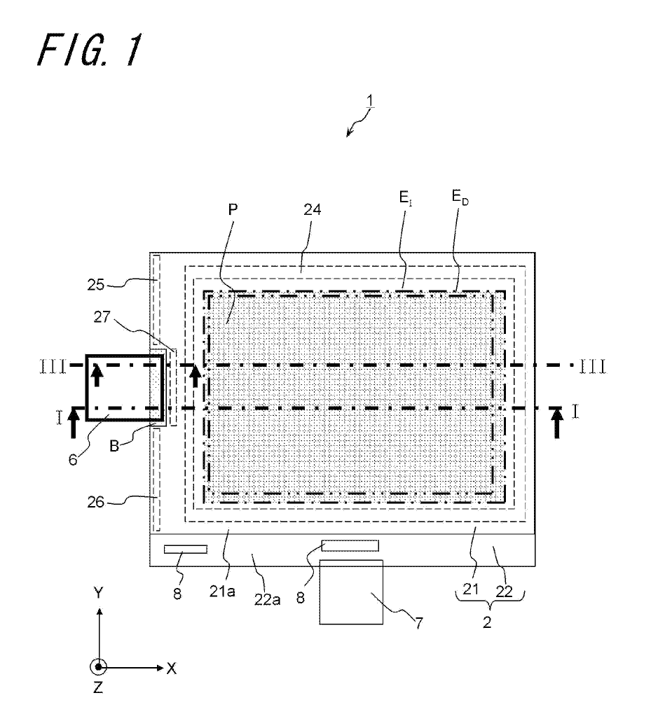

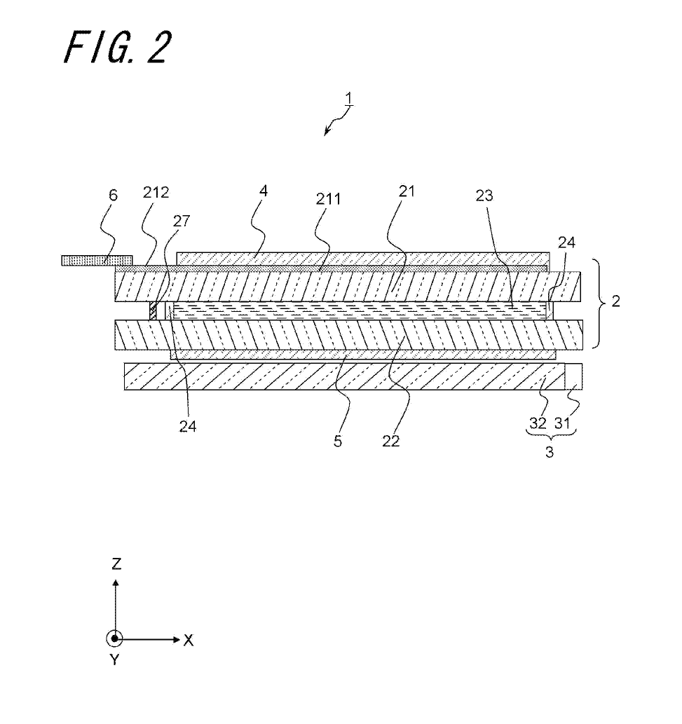

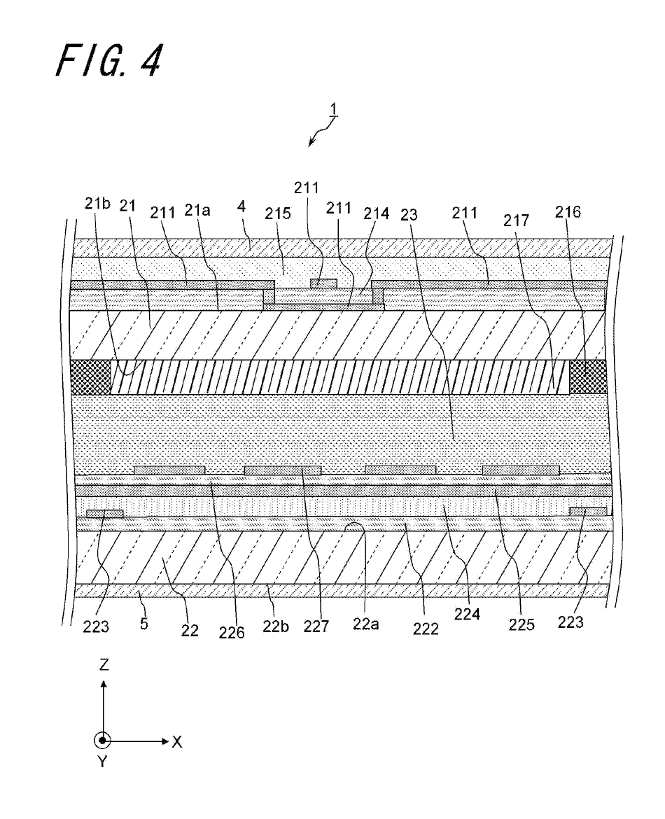

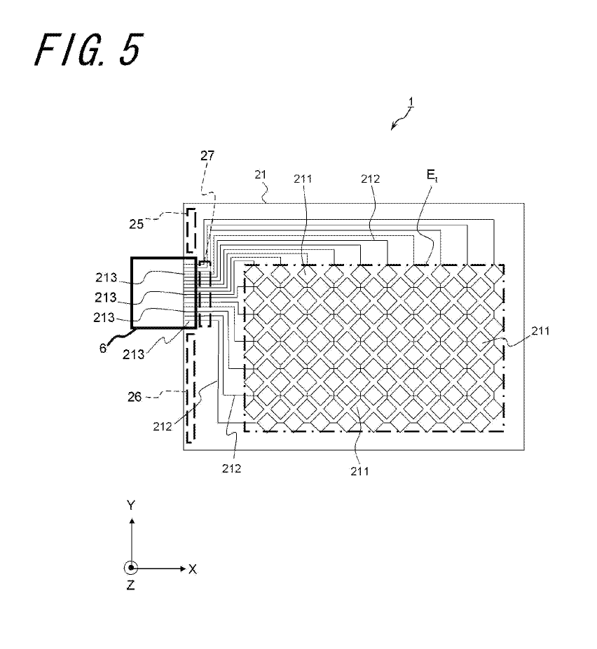

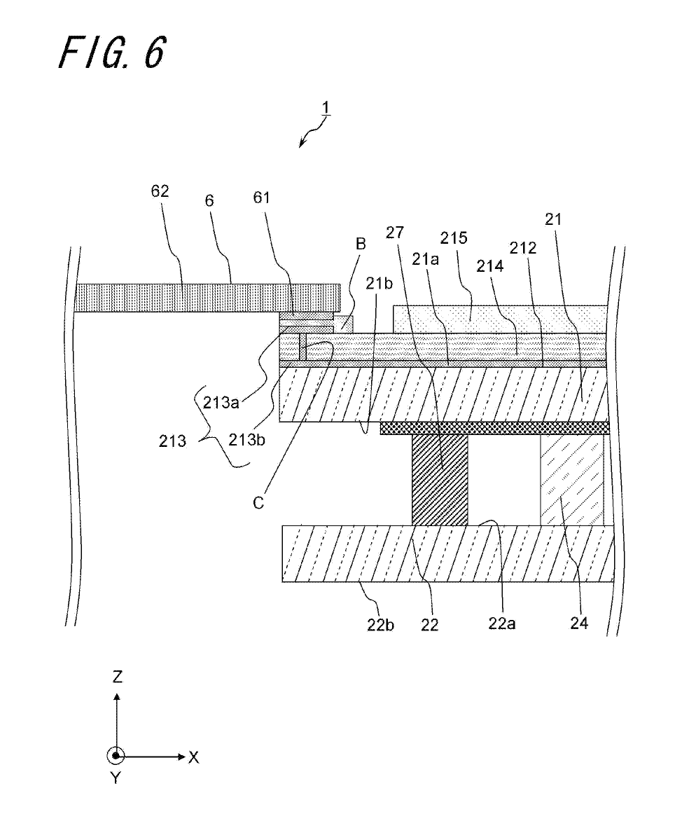

With reference to FIGS. 1 to 6, description will be given of a display apparatus 1 according to a first embodiment of the invention.

The display apparatus 1 includes a display panel 2; a light source device 3 which emits light to the display panel 2; a first polarizing plate 4 disposed on the display panel 2; a second polarizing plate 5 disposed between the display panel 2 and the light source device 3; and a first circuit board 6, a second circuit board 7, and driver ICs 8 which serve as a circuit board connected to the display panel 2. The display panel 2 according to this embodiment employs, as display means for displaying image information on a display region E_{D}, liquid crystal display means for generating an electric field between signal electrodes and a common electrode to control the orientation of liquid crystal molecules in a liquid crystal layer, thereby regulating transmittance of light from the light source device 3 for each pixel P and displaying an image on the display region E_{D}.

Moreover, the liquid crystal display means according to this embodiment adopts a so-called in-plane switching system that an electric field is generated between the signal electrodes and the common electrode disposed on one substrate of the pair of substrates so that the orientation of liquid crystal molecules in a liquid crystal layer is controlled. The liquid crystal display means of the display panel 2 according to this embodiment adopts the in-plane switching system, but not limited thereto. The liquid crystal display means may be of any types, and for example, a vertical alignment system may be adopted.

Moreover, the display means of the display panel 2 according to the invention is not limited to the liquid crystal display means, but may be display means employing plasma, electroluminescence, a light emitting diode, or the like.

The display panel 2 includes a first substrate 21 and a second substrate 22 which are disposed to be opposite to each other; a liquid crystal layer 23 situated between the first substrate 21 and the second substrate 22; and a sealing member 24 disposed to surround the liquid crystal layer 23, the sealing member 24 bonding the first substrate 21 and the second substrate 22 together. The display panel 2 also includes: a first spacer member 25 and a second spacer member 26 which are disposed between the first substrate 21 and the second substrate 22 along an edge of the first substrate 21; and a third spacer member 27 disposed between the first substrate 21 and the second substrate 22 along an end of the first circuit board 6.

The first substrate 21 has a first main surface 21a including the display region E_{D} composed of the plurality of pixels P and an input region E_{I} which overlays the display region E_{D}; and a second main surface 21b located on an opposite side to the first main surface 21a. Examples of a material of the first substrate 21 include a light-transmitting material such as glass.

A plurality of detection electrodes 211 have a function of detecting a change in capacitance between the input region E_{I} and input means, such as a finger, closely adjoining to the input region E_{I}. The plurality of detection electrodes 211 are disposed to overlay the input region E_{I}. The detection electrodes 211 each include a plurality of rhomboidal detection parts and a connection part connecting the adjacent detection parts to each other. Here, the shape of the detection part is not particularly limited. The detection electrodes 211, in which the plurality of detection parts are connected to each other by the connection part in a Y direction, are disposed in an X direction. On the other hand, the detection electrodes 211, in which the plurality of detection parts are connected to each other by the connection part in the X direction, are disposed in the Y direction. In a plan view, the connection parts of the detection electrodes 211 disposed in the X direction intersect with the connection parts of the detection electrodes 211 disposed in the Y direction.

The detection electrodes 211 disposed in the X direction are disposed on a first insulating film 214. The connection parts of the detection electrodes 211 disposed in the Y direction are disposed on the first main surface 21a of the first substrate 21. On the other hand, the detection parts of the detection electrodes 211 disposed in the Y direction are disposed on the first insulating film 214.

Here, the connection parts of the detection electrodes 211 disposed on the first main surface 21a of the first substrate 21 and the detection parts of the detection electrodes 211 disposed on the first insulating film 214 are connected to one another via contact holes which pass through the first insulating film 214. That is, the detection electrodes 211 disposed in the X direction and the detection electrodes 211 disposed in the Y direction are electrically insulated from one another by stereoscopically intersecting with one another via the first insulating film 214.

The detection electrodes 211 are made of a material having a light-transmitting property and a conductive property such as ITO (Indium Tin Oxide), ATO (Antimony Tin Oxide), AZO (Al-Doped Zinc Oxide), tin oxide, zinc oxide, or a conductive polymer.

Detecting lines 212 are disposed on the first main surface 21a of the first substrate 21. The detecting lines 212 are electrically connected to the detection electrodes 211. The detecting lines 212 are situated in a region outside the input region E_{I}. The detecting lines 212 are made of a conductive material such as ITO, tin oxide, aluminum, an aluminum alloy, silver, or a silver alloy.

The first insulating film 214 has a function of electrically insulating the intersecting detection electrodes 211 from each other. The first insulating film 214 is disposed to overlay the input region E_{I} and the region located outside the input region E_{I}. The first insulating film 214 is disposed on the first main surface 21a of the first substrate 21 so as to cover the connection parts of the detection electrodes 211 disposed in the Y direction and the plurality of detecting lines 212. The first insulating film 214 is made of a material having a light-transmitting property and an insulating property such as acrylic resin.

A second insulating film 215 is disposed on the first insulating film 214 so as to cover the detection parts of the detection electrodes 211 disposed in the Y direction and the detection electrodes 211 disposed in the X direction. The second insulating film 215 is situated in the input region E_{I} and the region located outside the input region E_{I}.

Electrode terminals 213 are electrically connected to the detection electrodes 211 via the detecting lines 212. Moreover, the electrode terminals 213 are connected to the first circuit board 6 via a conductive bonding member B. The electrode terminals 213 are disposed on the region located outside the input region E_{I}. The plurality of electrode terminals 213 are disposed along the edge (one side) of the first main surface 21a of the first substrate 21.

The electrode terminals 213 each include an upper-layer electrode terminal 213a and a lower-layer electrode terminal 213b. The lower-layer electrode terminal 213b is disposed on the first main surface 21a of the first substrate 21. The lower-layer electrode terminal 213b may be made of the same material as that for the detecting line 213. The first insulating film 214 is provided with a through hole C formed in a region where the lower-layer electrode terminal 213b is formed. A portion of the upper-layer electrode terminal 213a is situated inside the through hole C, and the remaining portion of the upper-layer electrode terminal 213a is situated on the first insulating film 214. The portion of the upper-layer electrode terminal 213a situated inside the through hole C is in contact with the lower-layer electrode terminal 213b, so that the upper-layer electrode terminal 213a and the lower-layer electrode terminal 213b are connected to each other. Here, the upper-layer electrode terminal 213a is made of a conductive material and is formed of, for example, an oxide conductive film such as ITO.

Next, description will be given of a principle of detecting an input position.

The plurality of detection electrodes 211 are disposed in the X direction and the Y direction in the input region E_{I} on the first main surface 21a of the first substrate 21. For example, the plurality of detection electrodes 211 disposed in the X direction are set to a fixed potential such as a ground potential, and signal voltage is applied to the plurality of detection electrodes disposed in the Y direction. As a result, an electric field is generated between the adjacent detection electrodes 211. In this state, bringing input means such as a user's finger or an input pen close to the input region E_{I} causes a change in magnitude of the electric field between the plurality of detection electrodes 211 on the region closely adjoining to the input means. This change is calculated as a variation in voltage by a controller (not shown) which is detection means. The controller compares the calculated value with a preset threshold value. When the calculated value exceeds the threshold value, the controller identifies the plurality of detection electrodes 211 at which the voltage varies. Then the controller determines, as an input position, the region where the plurality of identified detection electrodes are disposed.

A light shielding film 216 and color filters 217 are disposed on the second main surface 21b of the first substrate 21.

The light shielding film 216 has a function of shielding light. The light shielding film 216 is disposed on the second main surface 21b of the first substrate 21. The light shielding film 216 has a lattice shape formed along the contours of the pixels P. That is, the light shielding film 216 is formed to overlay gate lines 221 and source lines 223 in a plan view thereof. The light shielding film 216 according to this embodiment is formed into the lattice shape on the second main surface 21b, but not limited thereto. The light shielding film 216 is made of a resin to which a pigment or a dye of color with a high light shielding effect (e.g., black) is added, or a metal such as chromium.

The color filters 217 have a function of permitting transmission of only light with a specific wavelength of visible light. The plurality of color filters 217 are situated on the second main surface 21b of the first substrate 21, and are disposed on the pixels P, respectively. The respective color filters 217 have any of colors of red (R), green (G), and blue (B). The color filters 217 are not limited to the colors described above, but may have color such as yellow (Y) or white (W). The color filters 217 are made of a resin to which a dye or a pigment is added.

The second substrate 22 has a first main surface 22a facing the second main surface 21b of the first substrate 21, and a second main surface 22b on an opposite side to the first main surface 22a. The second substrate 22 can be made of a similar material to that for the first substrate 21.

The plurality of gate lines 221 are disposed on the first main surface 22a of the second substrate 22. Moreover, a gate insulating film 222 is disposed on the first main surface 22a of the second substrate 22 so as to cover the plurality of gate lines 221. The plurality of source lines 223 are disposed on the gate insulating film 222. Furthermore, a flattening film 224 is disposed on the gate insulating film 222 so as to cover the plurality of source lines 223. A common electrode 225 is disposed on the flattening film 224. Moreover, an interlayer insulating film 226 is disposed on the flattening film 224 so as to cover the common electrode 225. A plurality of signal electrodes 227 are disposed on the interlayer insulating film 226.

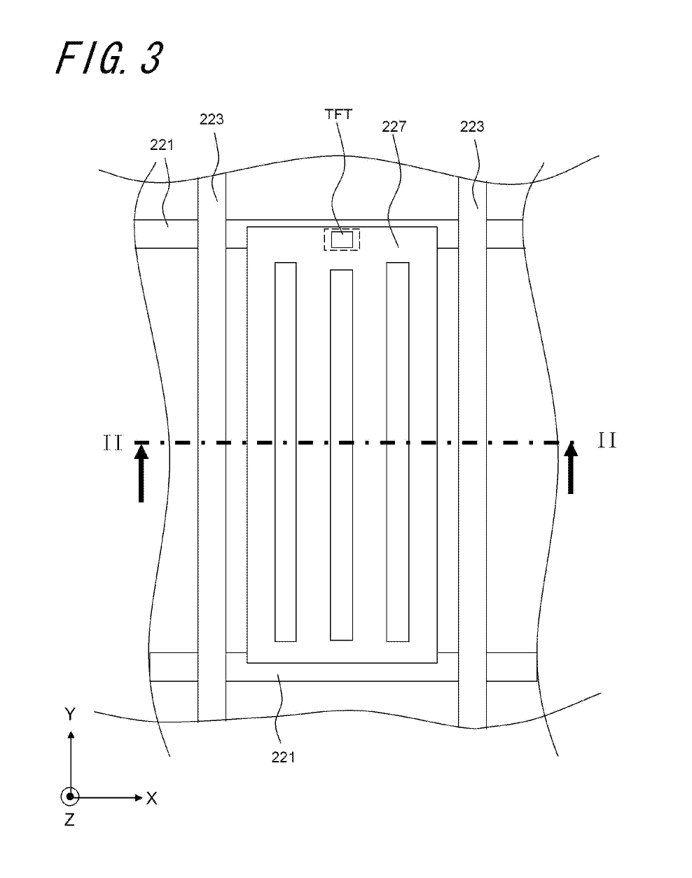

The gate lines 221 have a function of applying voltage supplied from the driver IC 8 to a thin-film transistor TFT. As shown in FIG. 3, the plurality of gate lines 221 are disposed parallel to the Y direction. Moreover, the gate lines 221 are formed into a linear shape and extend along the X direction.

The gate insulating film 222 is disposed on the first main surface 22a so as to cover the gate lines 221. The gate insulating film 222 is made of an insulating material such as silicon nitride or silicon oxide. Here, the gate insulating film 222 can be formed on the first main surface 22a of the second substrate 22 by sputtering described above, vapor deposition, chemical vapor deposition, or the like.

The source lines 223 have a function of applying signal voltage supplied from the driver IC 8 to the signal electrode 227 via the thin-film transistor TFT. The source lines 223 are disposed on the gate insulating film 222. As shown in FIG. 3, the plurality of source lines 223 are formed into a linear shape and extend along the Y direction. Moreover, the plurality of source lines 223 are disposed parallel to the X direction. The source lines 223 may be made of a similar material to that for the gate lines 221.

Here, the pixel P refers to a region surrounded by the plurality of gate lines 221 and the plurality of source lines 223.

The thin-film transistor TFT includes a semiconductor layer made of amorphous silicon, polycrystalline silicon, an oxide semiconductor, or the like; a source electrode situated on the semiconductor layer and connected to the source line 223; and a drain electrode. In the thin-film transistor TFT, the resistance of the semiconductor layer between the source electrode and the drain electrode varies in accordance with voltage to be applied to the semiconductor layer via the gate line 221. This variation allows control whether or not an image signal is written into the signal electrode 227.

The flattening film 224 is disposed on the gate insulating film 222 so as to cover the source lines 223. The flattening film 224 is made of an organic material. For example, the flattening film 224 is made of a resin such as acrylic resin, epoxy resin, or polyimide resin. Here, a thickness of the flattening film 224 is set to fall in a range of 1 μm to 5 μm, for example.

The common electrode 225 has a function of generating an electric field between the common electrode 225 and the signal electrode 227 based on voltage applied thereto from the driver IC 8. The common electrode 225 is disposed on the flattening film 224. The common electrode 225 is made of a material having a light-transmitting property and a conductive property such as ITO, ATO, AZO, tin oxide, zinc oxide, or a conductive polymer.

The interlayer insulating film 226 has a function of electrically insulating the signal electrode 227 and the common electrode 225 from each other. The interlayer insulating film 226 may be made of a similar material to that for the gate insulating film 222.

The signal electrodes 227 have a function of generating an electric field between the signal electrode 227 and the common electrode 225 based on signal voltage applied thereto from the driver IC 8. The plurality of signal electrodes 227 are disposed on the interlayer insulating film 226. Here, the signal electrodes 227 each have an opening formed therein. The signal electrodes 227 may be made of a similar material to that for the common electrode 225.

The liquid crystal layer 23 is disposed between the first substrate 21 and the second substrate 22. The liquid crystal layer 23 includes a nematic liquid crystal and the like.

The sealing member 24 has a function of sealing the liquid crystal layer 23 between the first substrate 21 and the second substrate 22. Moreover, the sealing member 24 bonds the first substrate 21 and the second substrate 22 together. The sealing member 24 is disposed between the first substrate 21 and the second substrate 22. The sealing member 24 is situated to surround a region which overlays the display region E_{D}. The sealing member 24 is made of epoxy resin or the like.

The first spacer member 25 is disposed between the first substrate 21 and the second substrate 22. The first spacer member 25 is disposed on one side of an outer region of the first circuit board 6 on an extension of a disposition direction of the plurality of electrode terminals 213. More specifically, the first spacer member 25 is disposed on the outer region at one side of the first circuit board 6 in the Y direction. Moreover, the first spacer member 25 is disposed along the edge (one side) of the first main surface 21a of the first substrate 21. The first spacer member 25 is disposed so as not to overlay the plurality of electrode terminals 213. The first spacer member 25 may be made of the same material as that for the sealing member 24.

The second spacer member 26 is disposed between the first substrate 21 and the second substrate 22. The second spacer member 26 is disposed on the other side of the outer region of the first circuit board 6 on the extension of the disposition direction of the plurality of electrode terminals 213. More specifically, the second spacer member 26 is disposed on the outer region at the other side of the first circuit board 6 in the Y direction, that is, at an opposite side to the first spacer member 25. Moreover, the first spacer member 25 is disposed along the edge (one side) of the first main surface 21a of the first substrate 21. The first spacer member 25 is disposed so as not to overlay the plurality of electrode terminals 213. The first spacer member 25 may be made of the same material as that for the sealing member 24.

The third spacer member 27 is disposed between the first substrate 21 and the second substrate 22. The third spacer member 27 is disposed along the end of the first circuit board 6 at an opposite side to the edge (one side) of the first main surface 21a of the first substrate 21. The third spacer member 27 according to this embodiment is disposed along the shorter side of the first circuit board 6 (the Y direction). Moreover, the third spacer member 27 is disposed so as not to overlay the input region E_{D}. The third spacer member 27 is also disposed so as not to overlay the plurality of electrode terminals 213. The third spacer member 27 may be made of the same material as that for the sealing member 24.

The conductive bonding member B is a bonding member having a conductive property, and contains conductive particles. The conductive bonding member B is formed of, for example, an anisotropic conductive film.

The first circuit board 6 is connected to the first substrate 21 via the conductive bonding member B. The first circuit board 6 partly faces the first substrate 21. The first circuit board 6 includes a base 61, wiring patterns, and circuit electrode terminals 62.

The base 61 has a function of supporting the plurality of wiring patterns and the plurality of circuit electrode terminals 62. The base 61 is made of an insulating material such as a resin. When the base 61 is made of a flexible material such as polyimide resin, the first circuit board 6 can be flexibly bent. Therefore, the display apparatus 1 can be mounted on electronic equipment or the like in a more compact manner.

The circuit electrode terminals 62 are connected to the electrode terminals 213 via the conductive bonding member B. That is, the respective circuit electrode terminals 62 face the respective electrode terminals 213. The circuit electrode terminals 62 are made of a conductive material such as copper.

The second circuit board 7 is connected to the second substrate 22 via the conductive bonding member B. The second circuit board 7 partly faces the second substrate 22. The plurality of electrode terminals 213 disposed along one side of the first main surface 21a of the first substrate 21 are connected to the first circuit board 6. Upon connection of the first substrate 21 to the first circuit board 6, first, the conductive bonding member B is disposed on the region where the plurality of electrode terminals 213 are disposed. Next, alignment is performed such that the respective electrode terminals 213 and the respective circuit electrode terminals 62 of the first circuit board 6 face each other. Thus, the first substrate 21 and the first circuit board 6 are connected to each other via the conductive bonding member B in such a manner that the first substrate 21 and the first circuit board 6 are bonded together by thermocompression.

When the first substrate 21 and the first circuit board 6 are bonded together by thermocompression, pressing force is applied to a site in the proximity of one side of the first substrate 21 where the plurality of electrode terminals 213 are disposed. The first substrate 21 is curved by the pressing force applied thereto, so that the pressing force is prone to being distributed. Therefore, the plurality of electrode terminals 213 cannot be satisfactorily connected to the circuit electrode terminals 62 in some cases.

Hence, the spacer members are formed between the first substrate 21 and second substrate 22 throughout one side of the first substrate 21 to support the site in the proximity of one side of the first substrate 21, so that strong pressing force is easily applied to the first circuit board 6. Thus, the conductive particles in the conductive bonding member B are easily embedded in the plurality of electrode terminals 213 and the plurality of circuit electrode terminals 62, so that the plurality of electrode terminals 213 can be connected to the plurality of circuit electrode terminals 62. This configuration allows improvement in electrical connection reliability between the electrode terminals 213 and the first circuit board 6.

On the other hand, when the spacer members are provided throughout one side of the first substrate 21, the spacer members overlays the connection region, where the electrode terminals 213 are connected to the first circuit board 6, between the first substrate 21 and the second substrate 22. Consequently, there is a possibility that the connection state between the electrode terminals 213 and the circuit electrode terminals 62 of the first circuit board 6 after thermocompression bonding cannot be verified in some cases.

In the display apparatus 1, hence, the first spacer member 25 is disposed along the edge of the first main surface 21a of the first substrate 21 at one side of the outer region of the first circuit board 6 on the extension of the disposition direction of the plurality of electrode terminals, and the second spacer member 26 is disposed along the edge of the first main surface 21a of the first substrate 21 at the other side. Thus, the site in the proximity of one side of the first substrate 21 can be supported by the first spacer member 25 and the second spacer member 26, and further, the connection state between the electrode terminals 213 and the first circuit board 6 can be verified from the second main surface 21b of the first substrate 21. Therefore, it is possible to provide the display apparatus 1 that ensures high connection reliability between the first substrate 21 and the first circuit board 6.

In the display apparatus 1, moreover, the third spacer member 27 is disposed between the first substrate 21 and the second substrate 22 along the end of the first circuit board 6 at the opposite side to the edge of the first main surface 21a of the first substrate 21. In the first substrate 21, thus, the site in the proximity of the end of the first circuit board 6 can be supported by the third spacer member 27. Therefore, the conductive particles in the conductive bonding member B are easily embedded in the plurality of electrode terminals 213 and the circuit electrode terminals 62. This configuration allows improvement in connection reliability between the electrode terminals 213 on the first substrate 21 and the first circuit board 6.

The light source device 3 has a function of emitting light toward the display panel 2. The light source device 3 includes a light source 31 and a light guide plate 32. In the light source device 3 according to this embodiment, the light source 31 adopts a point light source such as an LED, but may adopt a line light source such as a cold-cathode tube.

The first polarizing plate 4 has a function of selectively transmitting light having a predetermined oscillation direction. The first polarizing plate 4 is disposed to face the first main surface 21a of the first substrate 21 in the liquid crystal panel 2.

The second polarizing plate 5 has a function of selectively transmitting light having a predetermined oscillation direction. The second polarizing plate 5 is disposed to face the second main surface 22b of the second substrate 22.

The driver IC 8 has a function of performing control of drive for the gate line 221, the source line 223, or the like.

The driver IC 8 is disposed on the first main surface 21a of the second substrate 22. In this embodiment, two driver ICs 8, that is, the driver IC 8 for the gate lines 221 and the driver IC 8 for the source lines 223 are provided.

### Second Embodiment

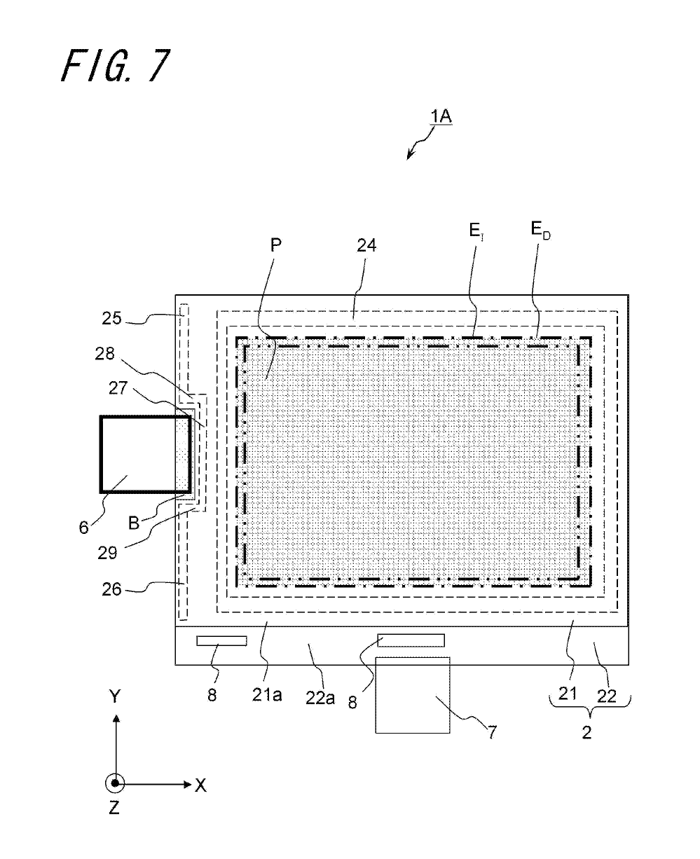

FIG. 7 is a plan view showing a main part of a display apparatus 1A according to a second embodiment.

The display apparatus 1A is different from the display apparatus 1 in that a fourth spacer member 28 connecting the third spacer member 27 and the first spacer member 25 to each other and a fifth spacer member 29 connecting the third spacer member 27 and the third sealing member 26 to each other are disposed between a first substrate 21 and a second substrate 22.

In the display apparatus 1A, the fourth spacer member 28 connects the third spacer member 27 and the first spacer member 25 to each other, and the fifth spacer member 29 connects the third spacer member 27 and the second spacer member 26 to each other. Therefore, a site of the first substrate 21 in the proximity of an end side of a first circuit board 6 can be supported by the fourth spacer member 28 and the fifth spacer member 29. Moreover, conductive particles in a conductive bonding member B are easily embedded in the plurality of electrode terminals 213 and the circuit electrode terminals 62. This configuration allows improvement in connection reliability between the electrode terminals 213 on the first substrate 21 and the first circuit board 6.

The invention is not particularly limited to the first and second embodiments, and various modifications and improvements are possible within the scope of the invention.

### REFERENCE SIGNS LIST

1, 1A: Display apparatus

2: Display panel

E_{d}: Display region

P: Pixel

E_{I}: Input region

21: First substrate

21a: First main surface (Outer main surface)

21b: Second main surface (Outer main surface)

211: Detection electrode

212: Detecting line

213: Electrode terminal

213a: Upper electrode terminal

213b: Lower electrode terminal

214: First insulating film

215: Second insulating film

216: Light shielding film

217: Color filter

22: Second substrate

22a: First main surface (Outer main surface)

22b: Second main surface (Inner main surface)

221: Gate line

222: Gate insulating film

223: Source line

224: Flattening film

225: Common electrode

226: Second interlayer insulating film

227: Signal electrode

TFT: Thin-film transistor

B: Conductive bonding member

23: Liquid crystal layer

24: Sealing member

25: First spacer member

26: Second spacer member

27: Third spacer member

28: Fourth spacer member

29: Fifth spacer member

3: Light source device

31: Light source

32: Light guide plate

4: First polarizing plate

5: Second polarizing plate

6: First circuit board

61: Base

62: Circuit electrode terminal

7: Second circuit board

8: Driver IC

1. A display apparatus, comprising:
a first substrate having in an outer main surface thereof a display region and an input region which overlays the display region;
a second substrate disposed relative to the first substrate so that an inner main surface of the second substrate and an inner main surface of the first substrate are opposite to each other;
a sealing member disposed between the first substrate and the second substrate to surround a region which overlays the display region;
detection electrodes disposed on the outer main surface of the first substrate to overlay the input region;
a plurality of electrode terminals for external connection disposed along an edge of the outer main surface of the first substrate in a region which overlays a region of the second substrate which region is located outside the input region, the electrode terminals being electrically connected to the detection electrodes;
a circuit board disposed to be opposite to the plurality of electrode terminals and connected to the electrode terminals via a conductive bonding member;
a first spacer member disposed along the edge of the outer main surface of the first substrate at one side of an outer region of the circuit board on an extension of a disposition direction of the plurality of electrode terminals; and a second spacer member disposed along the edge of the outer main surface of the first substrate at the other side of the outer region being disposed between the first substrate and the second substrate.

2. The display apparatus according to claim 1, wherein
a third spacer member disposed along an end of the circuit board which end is on an opposite side to the edge of the outer main surface of the first substrate is provided between the first substrate and the second substrate not to overlay the input region.

3. The display apparatus according to claim 2, wherein
a fourth spacer member for connecting the third spacer member and the first spacer member to each other and a fifth spacer member for connecting the third spacer member and the second spacer member to each other are provided between the first substrate and the second substrate.
